(19) United States
(12) Patent Application Publication
(10) Pub. No.: US 2021/0284550 A1
(43) Pub. Date: Sep. 16, 2021

(54) LITHIUM-TITANIUM COMPLEX OXIDE, PREPARATION METHOD THEREOF, AND LITHIUM SECONDARY BATTERY COMPRISING SAME

(71) Applicant: POSCO CHEMICAL CO., LTD, Pohang-si, Gyeongsangbuk-do (KR)

(72) Inventors: Su Bong CHOI, Gumi-si, Gyeongsangbuk-do (KR); Chun Gu KANG, Seoul (KR); Jeong Eun CHOI, Chungcheongbuk-do (KR); Seung Chang JEONG, Andong-si, Gyeongsangbuk-do (KR); Jae An LEE, Gumi-si, Gyeongsangbuk-do (KR); Jeong Han KIM, Gumi-si, Gyeongsangbuk-do (KR)

(21) Appl. No.: 16/489,606

(22) PCT Filed: May 26, 2017
(86) PCT No.: PCT/KR2017/005538

§ 371 Date: Aug. 28, 2019

(30) Foreign Application Priority Data
Nov. 22, 2016 (KR) 10-2016-0155628

(51) Int. Cl. C01G 23/00; B22F 9/02; B22F 9/04

(52) U.S. Cl. CPC C01G 23/005; B22F 9/026; B22F 9/04; C01P 2006/12; B22F 2302/25; C01P 2004/62; C01P 2006/11; B22F 2304/05; C01P 2006/10

(57) ABSTRACT

The present invention relates to a lithium-titanium complex oxide, a preparation method thereof, and a lithium secondary battery comprising the same and, more specifically, to a lithium-titanium complex oxide which maintains appropriate pores within particles, and which is prepared by adding a pore inducing material in the wet-milling step to adjust sizes of primary particles of the lithium-titanium complex oxide, a preparation method thereof, and a lithium secondary battery comprising the same.

### CROSS-REFERENCE TO RELATED APPLICATIONS

This application is the U.S. national stage application of International Patent Application No. PCT/KR2017/005538, filed May 26, 2017, which claims the benefit under 35 U.S.C. § 119 of Korean Patent Application No. 10-2016-0155628, filed Nov. 22, 2016, the disclosures of each of which are incorporated herein by reference in their entirety.

### BACKGROUND OF THE INVENTION

### Field of the invention

The present invention relates to a lithium-titanium complex oxide, a preparation method thereof, and a lithium secondary battery comprising the same and, more specifically, to a lithium-titanium complex oxide which maintains appropriate pores within particles by adding a pore inducing material in the wet-milling step, and which is prepared by adjusting sizes of primary particles of the lithium-titanium complex oxide, a preparation method thereof, and a lithium secondary battery comprising the same.

### Related Art

Secondary batteries have currently been used as a primary power source in an energy storage technology applying field such as a mobile phone, a camcorder, a notebook PC, and an electric vehicle. Application ranges of such secondary batteries are being gradually expanded from a nanoscaled micro device to a power storage device for a movable device such as a notebook computer, and an electric vehicle and a smart grid.

Recently, lithium ion secondary batteries have been spotlighted in electric vehicle and power storage fields, and more excellent electrochemical characteristics of the secondary batteries are required in order to use the secondary batteries in such fields.

Particularly, a lithium-titanium complex oxide having a high Li occlusion/release electric potential has been receiving attention, and typical examples of the lithium-titanium complex oxide (LTO) include Li_{4/3}Ti_{5/3}O₄, LiTi₂O₄, and Li₂TiO₃. Since this material has conventionally been used as a cathode active material, and can be also used as an anode active material, the future of this material as the cathode and anode active materials of batteries is expected. Electrolyte decomposition is rarely generated in the lithium-titanium complex oxide, and the lithium-titanium complex oxide has excellent cycle characteristics due to structural stability since an oxidation/reduction potential of an anode is about 1.5 V which is a relatively high value with respect to an electric potential of Li/Li⁺ in the lithium-titanium complex oxide as a material having a spinel structure that is a typical oxide in which intercalation or deintercalation of lithium occurs in a state that a crystal structure is maintained.

For example, as a conventional lithium titanate (Li₄Ti₅O₁₂) preparation method which is the most common, a method of calcining the mixture at 800° C. or more in an oxygen atmosphere by mixing Anatase titanium dioxide with lithium hydroxide has been known as described in Japanese Patent Laid-Open Publication No. Hei 07-320784, Japanese Patent Laid-Open Publication No. 2001-192208, etc. Lithium titanate is easily handled due to a low viscosity during preparation of an electrode mixture slurry since lithium titanate which can be obtained by this preparation method has a relatively low specific surface area of 10 m²/g or less. Further, when manufacturing the lithium ion secondary batteries using lithium titanate that can be obtained by the above-described preparation method, it is difficult that cycle deterioration of the lithium ion secondary batteries occurs, and the lithium ion secondary batteries have high safety. However, since capacity deterioration of the above-described lithium ion secondary batteries during high power charging and discharging is great, i.e., rate performance of the lithium ion secondary batteries is lower, it is difficult to applying the lithium ion secondary batteries to on-vehicle applications and the like

Further, although the lithium-titanium complex oxide has an advantage of excellent rapid charging or low temperature performance since metal lithium is not precipitated in principle at a lithium occlusion/release electric potential, the lithium-titanium complex oxide has disadvantages of a low capacity per unit weight and a low energy density.

In order to solve these problems, it is required to develop an active material which has a low internal resistance and a high electrical conductivity and is excellent in output characteristics while complementing the disadvantages of the lithium-titanium complex oxide.

### SUMMARY OF THE INVENTION

In order to solve above-mentioned problems, an objective of the present invention is to provide a novel preparation method of a lithium-titanium complex oxide, the preparation method comprising adding a pore inducing material for forming appropriate pores within particles produced while controlling particle sizes of a slurry in the preparation process.

Further, the other objective of the present invention is to provide a lithium-titanium complex oxide prepared by the preparation method of the present invention and a lithium secondary battery comprising the same.

In order to achieve the objectives, the present invention provides a lithium-titanium complex oxide having a molar ratio of lithium to titanium (Li/Ti ratio) of 0.80 to 0.85.

The lithium-titanium complex oxide according to the present invention may comprise 5 wt % or less of a rutile-type titanium oxide. Namely, the rutile-type titanium oxide is contained in the lithium-titanium complex oxide in an amount of 5 wt % or less with respect to 100 parts by weight of the entire lithium-titanium complex oxide. Inherently, a portion of spinel type lithium titanate is phase separated into a rutile-type TiO₂(r-TiO₂) during the preparation process. This rutile-type TiO₂(r-TiO₂) has a problem of decreasing an effective capacity of lithium titanate obtained since the rutile-type TiO₂(r-TiO₂) has a low reaction speed, an inclined potential curve and a small capacity although the rutile-type TiO₂(r-TiO₂) is electrochemically active by having a rock salt structure. An amount of the rutile-type titanium oxide contained in the lithium-titanium complex oxide according to the present invention may be adjusted to 5 wt % or less.

The lithium-titanium complex oxide according to the present invention may comprise 0.05 mol/L or less of Zr.

The lithium-titanium complex oxide according to the present invention may have a Brunauer-Emmett-Teller (BET) surface areas of 4.3 m²/g or more, a tap density of 1.0 g/cm³ or more, and a pellet density of 1.75 g/cm³ or more.

The tap density of the lithium-titanium complex oxide according to the present invention means a value obtained when performing a tapping process 3,000 times after injecting a sample into INTEC ARD-200 equipment, and the pellet density of the lithium-titanium complex oxide according to the present invention means a value obtained when performing a pressurizing process using a pressure of 1.6 ton after injecting 1 g of a sample into Carver Modal-4350 equipment.

Furthermore, the present invention provides a preparation method of the lithium-titanium complex oxide according to the present invention comprising:

a first step of solid phase-mixing a pore inducing compound, a titanium compound, and a dissimilar metal-containing compound at a stoichiometric ratio to obtain a solid phase mixture;

a second step of preparing a slurry in which primary particles are dispersed by dispersing the solid phase mixture in a solvent and wet-milling the solid phase mixture dispersed in the solvent;

a third step of forming secondary particles by spray drying the slurry;

obtain lithium compound-mixed particles;

a fifth step of calcining the lithium compound-mixed particles to obtain calcined particles; and

a sixth step of classifying the calcined particles.

In the preparation method according to the present invention, the pore inducing compound may be one or more selected from the group consisting of lithium carbonate (Li₂CO₃), sodium bicarbonate (NaHCO₃), and potassium carbonate (K₂CO₃).

In the preparation method according to the present invention, the titanium compound may be one or more selected from the group consisting of titanium dioxide (TiO₂), titanium chloride, titanium sulfide, and titanium hydroxide.

In the preparation method according to the present invention, the dissimilar metal may be one or more selected from the group consisting of Na, Zr, K, B, Mg, Al, and Zn.

In the preparation method according to the present invention, the wet-milling process in the second step may comprise wet-milling the solid phase mixture dispersed in the solvent by using water as the solvent and using zirconia beads having a rotational speed of 2,000 to 5,000 rpm.

In the preparation method according to the present invention, the zirconia beads may have a particle diameter of 0.1 to 0.3 mm.

In the preparation method according to the present invention, the primary particle in the second step may have an average particle diameter D₅₀ of 0.05 to 0.4 μm.

In the preparation method according to the present invention, the third step of performing the spray drying process may comprise spray drying the slurry at a hot air input temperature of 200 to 300° C. and a hot air exhaust temperature of 100 to 150° C.

In the preparation method according to the present invention, the second particles obtained by spray drying the slurry in the third step may have a diameter D₅₀ of 5 to 20 μm.

In the preparation method according to the present invention, the lithium-containing compound in the fourth step may be lithium hydroxide (LiOH) or lithium carbonate (Li₃CO₂).

In the preparation method according to the present invention, the calcination process in the fifth step may be performed at a temperature of 700 to 800° C. in an air atmosphere for 10 to 20 hours.

In the preparation method according to the present invention, density and initial capacity may be lowered when the calcination process is performed at a temperature of 700° C. or less while specific surface area may be decreased, and rate properties may be lowered when the calcination process is performed at a temperature of 800° C. or more.

In the preparation method according to the present invention, the sixth step may comprise classifying the calcined particles to a particle size corresponding to a sieve size of 200 to 400 meshes.

### BRIEF DESCRIPTION OF THE DRAWINGS

FIG. 1 is a schematic diagram illustrating a preparation method according to the present invention.

FIG. 2A to FIG. 2G show SEM (Scanning Electron Microscope) results of lithium-titanium complex oxides prepared in Comparative Example 1 and Examples 1 to 6 of the present invention.

FIG. 3A to FIG. 3F show SEM results of cross-sections of the lithium-titanium complex oxides prepared in Comparative Example 1 and Examples 1 to 6 of the present invention.

FIG. 4A to FIG. 4G show SEM results of active materials after analyzing pellet densities of active materials prepared in Comparative Example 1 and Examples 1 to 6 of the present invention.

FIG. 5A to FIG. 5J show SEM results of secondary particles of lithium-titanium complex oxides which are prepared in particle size-controlled primary particles by Comparative Examples 2 to 6 according to the present invention.

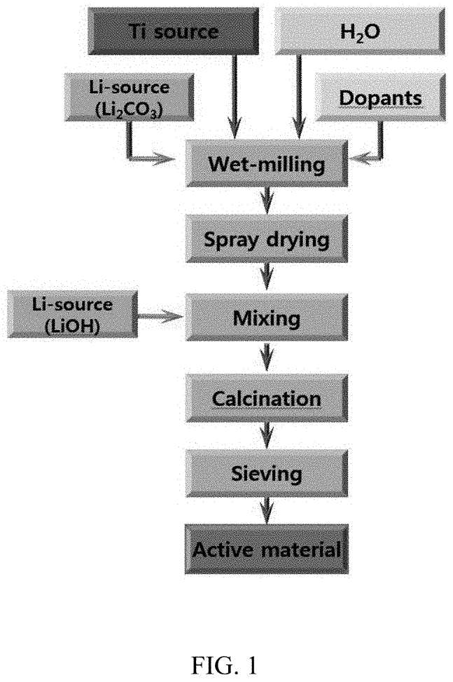

### DESCRIPTION OF EXEMPLARY EMBODIMENTS

Hereinafter, the present invention is described more in detail by Examples. However, the present invention is not limited by the following Examples.

### EXAMPLES 1 TO 18

### Preparation of Pore Induced In Compound-Added Lithium-Titanium Complex Oxides

After obtaining solid phase mixtures by solid phase-mixing titanium oxide as a starting material, lithium carbonate as a pore inducing compound, and zirconium oxide as a dissimilar metal, the solid phase mixtures were stirred and dissolved in water to obtain mixtures. The mixtures were designed such that molar ratios of lithium contents to titanium contents (Li/Ti ratios) became 0.81 by adjusting equivalent weights of lithium carbonates compared to lithium hydroxides.

After wet-milling particles of the mixtures into primary particles having an average particle diameter of 0.12 μm at a milling speed of 4,200 rpm using zirconia beads to prepare slurries, spray drying the slurries at a hot air input temperature of 250° C. and a hot air exhaust temperature of 110° C., and adding lithium hydroxide to the spray dried slurries to mix lithium hydroxide with the spray dried slurries at a rotational speed 700 rpm for 10 minutes using a Herschel mixer, active materials were prepared by calcining the mixtures at 750 to 780° C. to obtain calcined products and classifying the calcined products using a sieve having a sieve size corresponding to 325 meshes.

TABLE 1

| Classification | LiOH:Li₂CO₃ | Calcination temperature |
|---|---|---|
| Example 1 | 90:10 | 750° C. |
| Example 2 | 70:30 | 750° C. |
| Example 3 | 50:50 | 750° C. |
| Example 4 | 30:70 | 750° C. |
| Example 5 | 10:90 | 750° C. |
| Example 6 | 0:100 | 750° C. |
| Example 7 | 95:5 | 760° C. |
| Example 8 | 90:10 | 760° C. |
| Example 9 | 85:15 | 760° C. |
| Example 10 | 80:20 | 760° C. |
| Example 11 | 95:5 | 770° C. |
| Example 12 | 90:10 | 770° C. |
| Example 13 | 85:15 | 770° C. |
| Example 14 | 80:20 | 770° C. |
| Example 15 | 95:5 | 780° C. |
| Example 16 | 90:10 | 780° C. |
| Example 17 | 85:15 | 780° C. |
| Example 18 | 80:20 | 780° C. |

### COMPARATIVE EXAMPLE 1

### Preparation of a Lithium-Titanium Complex Oxide

After obtaining a solid phase mixture by solid phase-mixing 0.01 mol of titanium oxide and zirconium hydroxide as starting materials without adding a pore inducing compound, a mixture was obtained by stirring the solid phase mixture in water, thereby dissolving the solid phase mixture in water.

After wet-milling particles of the mixture into primary particles having an average particle diameter of 0.12 μm at a milling speed of 4,200 rpm using zirconia beads having a particle diameter of 0.1 mm to prepare a slurry, spray drying the slurry at a hot air input temperature of 250° C. and a hot air exhaust temperature of 110° C., and adding lithium hydroxide to the spray dried slurry to mix lithium hydroxide with the spray dried slurry at a rotational speed 700 rpm for 10 minutes using a Herschel mixer, an active material was prepared by calcining the mixture at 750° C. to obtain a calcined product and classifying the calcined product using a sieve having a sieve size corresponding to 325 meshes.

### COMPARATIVE EXAMPLES 2 TO 6

### Preparation of Lithium-Titanium Complexes of Which Primary Particles are Particle Size-Controlled by Wet-Milling

After obtaining solid phase mixtures by solid phase-mixing 0.01 mol of titanium oxide and zirconium hydroxide as starting materials without adding a pore inducing compound, mixtures were obtained by stirring the solid phase mixtures in water, thereby dissolving the solid phase mixtures in water.

After wet-milling particles of the mixtures into primary particles having average particle diameters of 0.40 μm, 0.30 μm, 0.20 μm, 0.15 μm and 0.10 μm using zirconia beads having a particle diameter of 0.1 mm to prepare slurries, spray drying the slurries at a hot air input temperature of 250° C. and a hot air exhaust temperature of 110° C., and adding lithium hydroxide to the spray dried slurries to mix lithium hydroxide with the spray dried slurries at a rotational speed 700 rpm for 10 minutes using a Herschel mixer, active materials were prepared by calcining the mixtures at 750° C. to obtain calcined products and classifying the calcined products.

TABLE 2

| Classification | | Primary particle size |
|---|---|---|
| Comparative Example 2 | SPL-1 | 0.40 μm |
| Comparative Example 3 | SPL-2 | 0.30 μm |
| Comparative Example 4 | SPL-3 | 0.20 μm |
| Comparative Example 5 | SPL-4 | 0.15 μm |
| Comparative Example 6 | SPL-5 | 0.10 μm |

### EXPERIMENTAL EXAMPLE

### Measurement of SEM Photographs

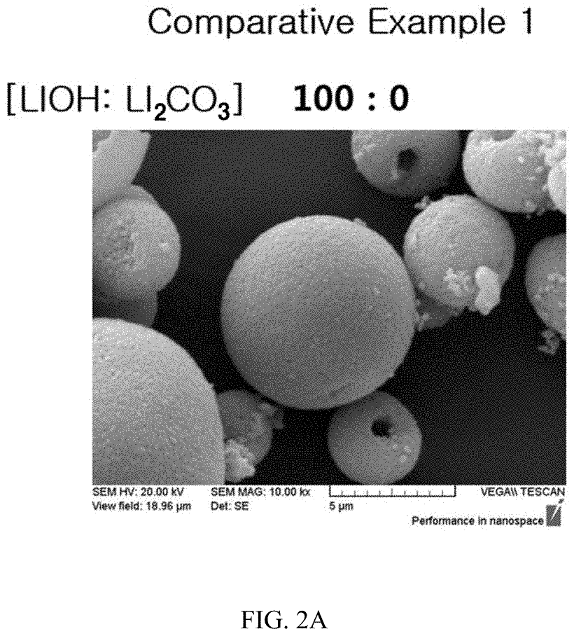

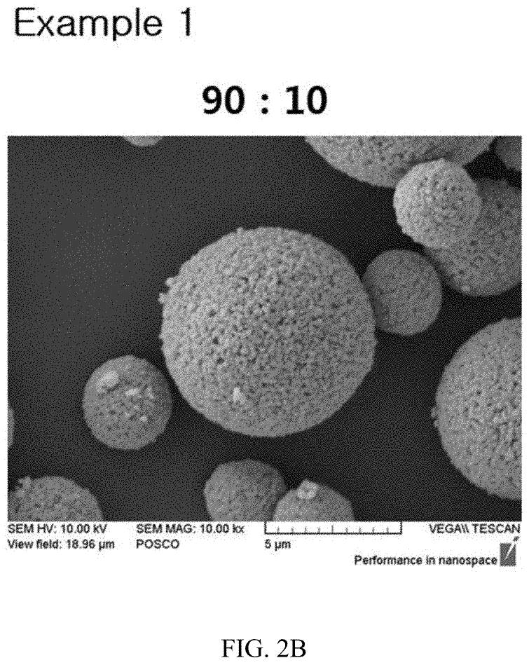

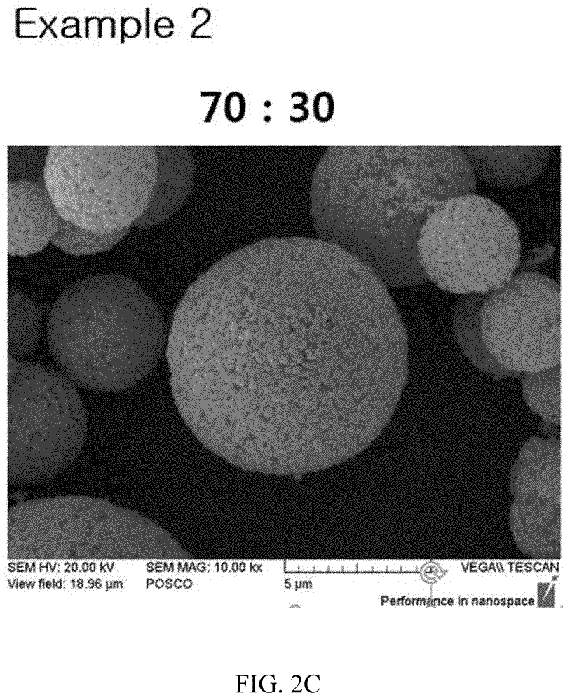

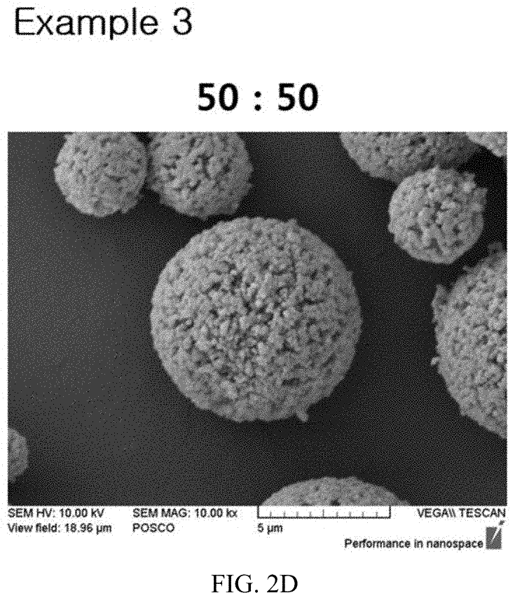

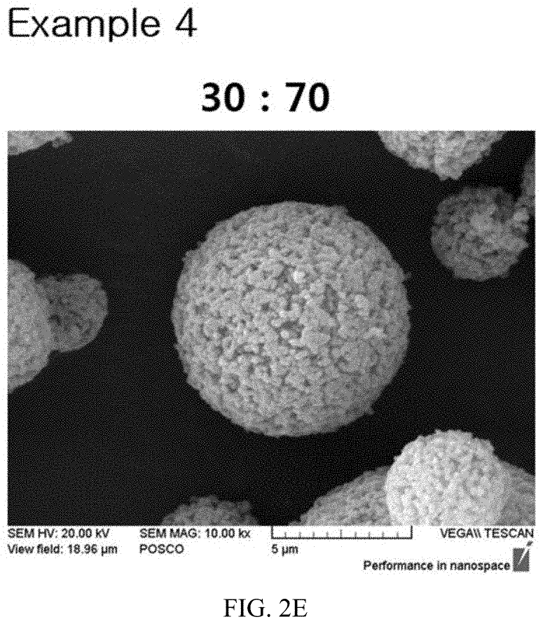

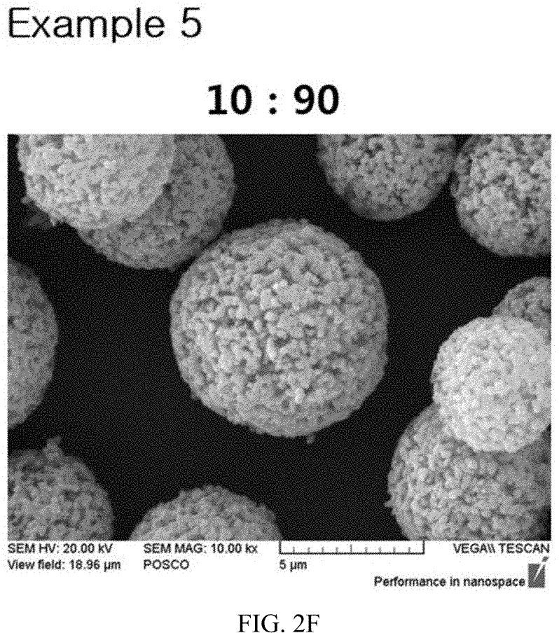

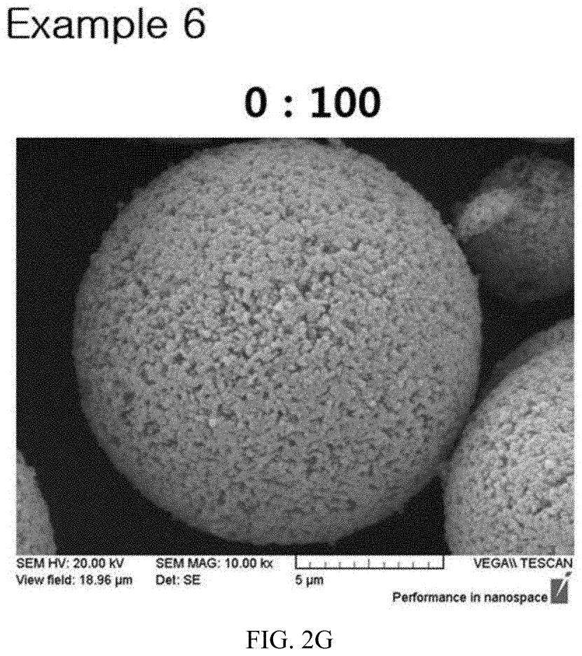

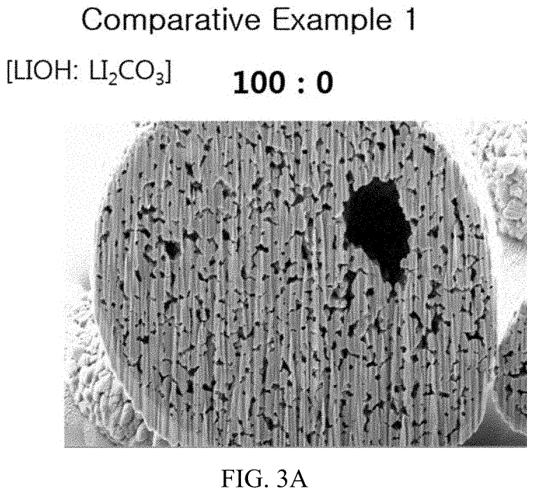

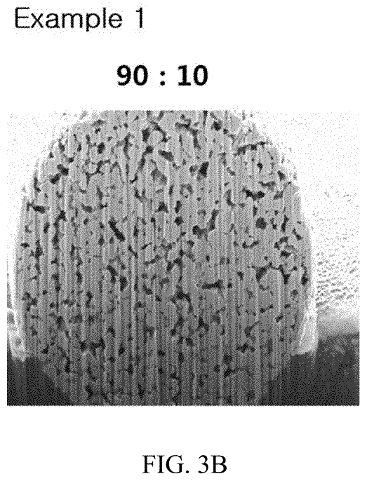

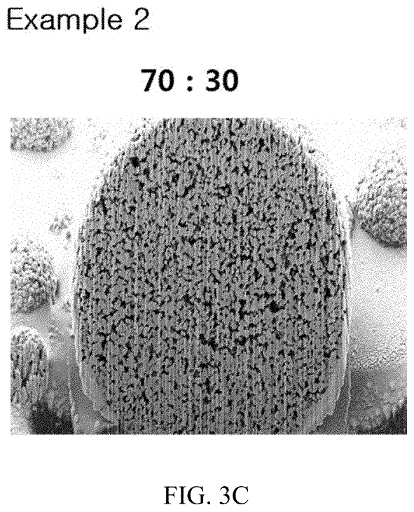

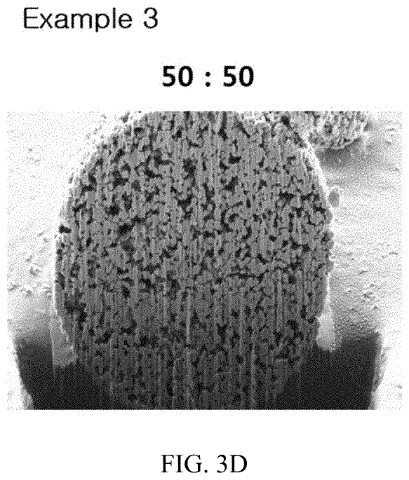

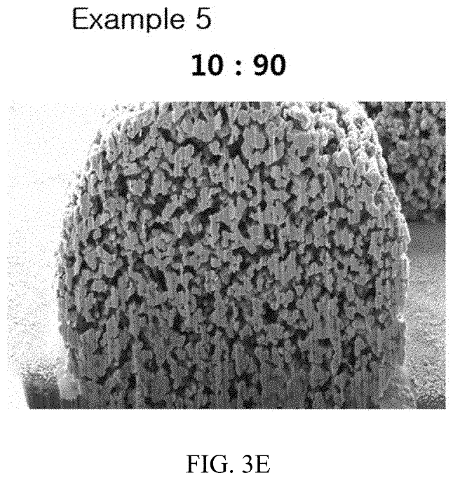

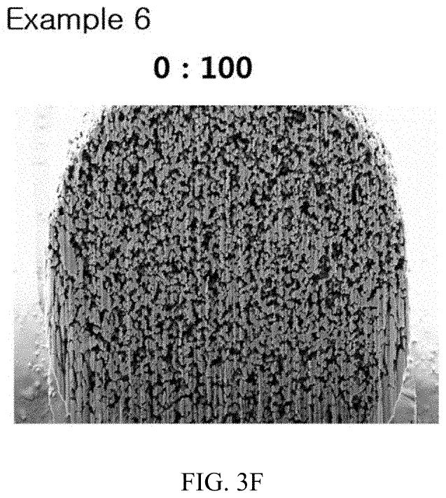

After measuring SEM photographs of the active materials prepared in Examples 1 to 6 and Comparative Example 1, measurement results are shown in FIG. 2A to FIG. 2G and FIG. 3A to FIG. 3F.

In FIG. 2A to FIG. 2G, it can be seen that the more contents of Li₂CO₃ added as a pore inducting material are increased, the more pores are formed within the particles, and it can be seen that formation ratios of doughnut shaped particles of the lithium-titanium complex oxides are low in secondary particles of lithium-titanium complex oxides of Examples 2 to 6 formed of primary particles having an average particle diameter of 0.12 μm. The doughnut shaped particles are formed in such a form that the electrode is easily crushed in the rolling process after manufacturing an electrode from the active material. Therefore, it has been known that the doughnut shaped particles can cause deterioration of battery capacity.

After preparing particles by varying addition amounts of Li₂CO₃ added as the pore inducing material, SEM photographs of cross-sections of the respective prepared particles are shown in FIG. 3A to FIG. 3F. It can be seen in FIG. 3A to FIG. 3F that the more the addition amounts of Li₂CO₃ added as the pore inducing material are increased, the more uniformly pores are formed in the particles.

SEM results of the lithium-titanium complex oxides of Comparative Examples 2 to 6 of which primary particles have controlled particle sizes are shown in FIG. 3A to FIG. 3F. As shown in FIG. 3A to FIG. 3F, it can be seen that the smaller particles of the slurries become, the smaller primary particles of the active materials also become, and it can be seen that large amounts of doughnut shaped particles are generated when the primary particles of the slurries of Comparative Examples 2 to 6 to which the pore inducing compound is not added have a particle diameter D₅₀ of 0.2 μm or less.

### EXPERIMENTAL EXAMPLE

### Measurement of the Surface Area

After measuring surface areas of the active materials prepared in Examples and Comparative Example 1 using BET equipment, measurement results are shown in Table 3.

In Table 3, since the more contents of Li₂CO₃ added as the pore inducting material are increased, the smaller and the more uniformly the pores are dispersed and formed to be, it can be seen that BET surface area values of 4.3 m³/g or more of Examples are increased than that of Comparative Example, and this, as a decarboxylation reaction due to Li₂CO₃ added as the pore inducting material, results from the formation of internal pores.

TABLE 3

| | Active material | | |
|---|---|---|---|
| | Tap density | Pellet density | BET surface area |
| Classification | [g/ml] | [g/cm³] | [m²/g] |
| Comparative | 0.81 | 1.76 | 3.4 |
| Example | | | |
| Example 1 | 1.18 | 1.72 | 5.3 |
| Example 2 | 0.98 | 1.67 | 5.8 |
| Example 3 | 0.87 | 1.71 | 5.9 |
| Example 4 | 0.77 | 1.72 | 6.0 |
| Example 5 | 0.70 | 1.71 | 6.8 |
| Example 6 | 0.75 | 1.71 | 7.7 |
| Example 7 | 1.15 | 1.76 | 4.7 |
| Example 8 | 1.13 | 1.74 | 5.0 |
| Example 9 | 1.10 | 1.73 | 5.1 |
| Example 10 | 1.08 | 1.71 | 5.5 |
| Example 11 | 1.15 | 1.77 | 4.4 |
| Example 12 | 1.15 | 1.75 | 4.6 |
| Example 13 | 1.13 | 1.75 | 4.6 |
| Example 14 | 1.11 | 1.74 | 4.7 |
| Example 15 | 1.16 | 1.78 | 4.3 |
| Example 16 | 1.15 | 1.76 | 4.5 |
| Example 17 | 1.16 | 1.76 | 4.5 |
| Example 18 | 1.15 | 1.75 | 4.6 |

### EXPERIMENTAL EXAMPLE

### Measurement of Tap Densities and Pellet Densities

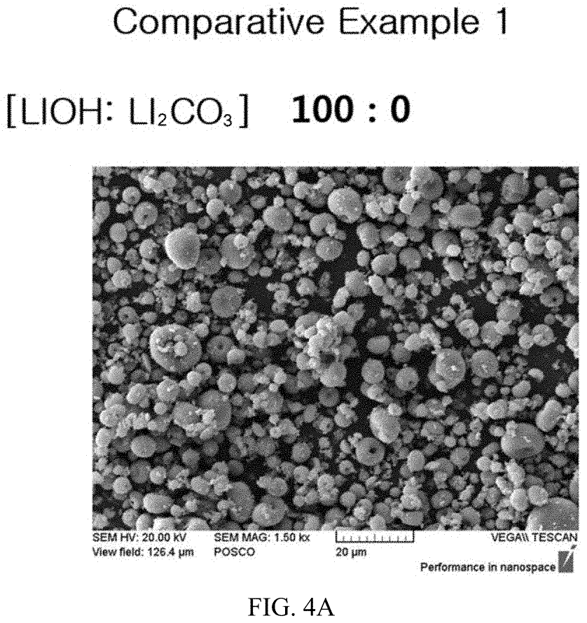

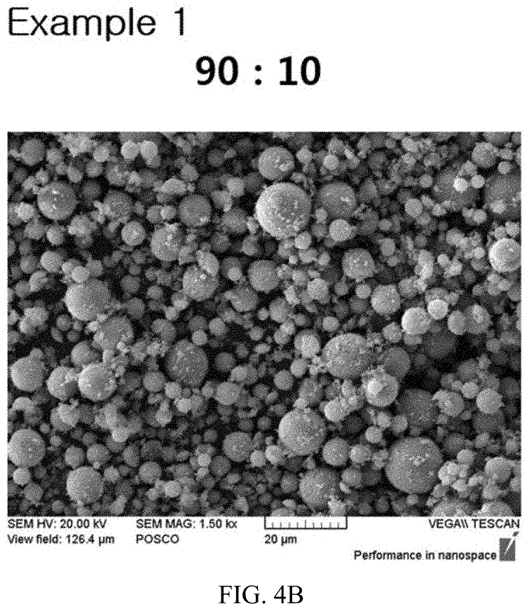

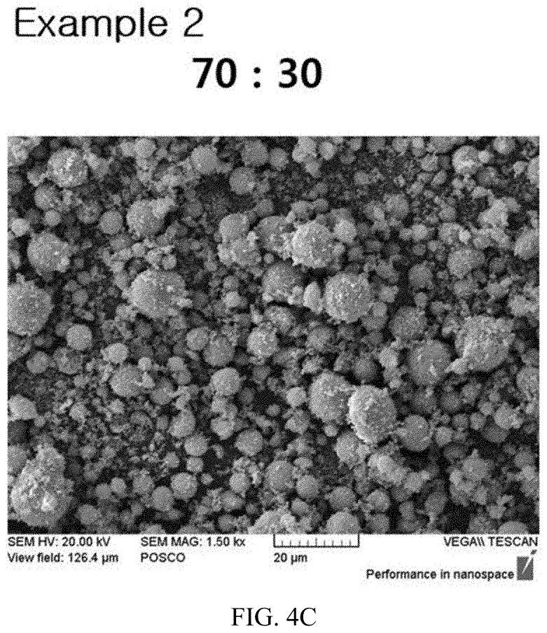

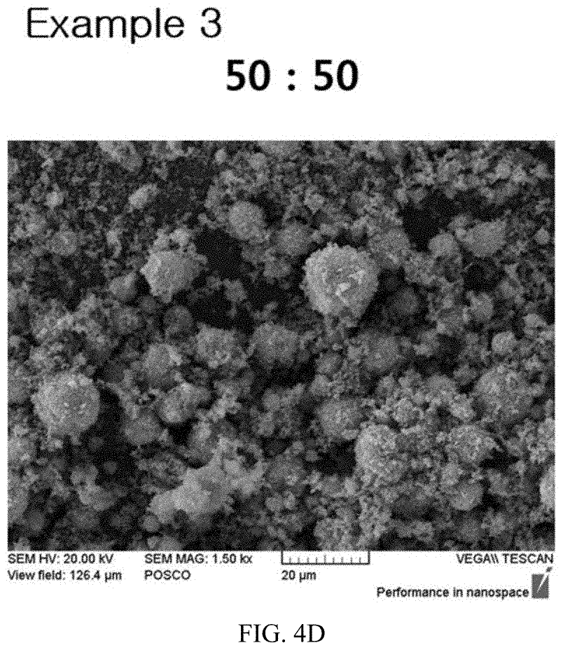

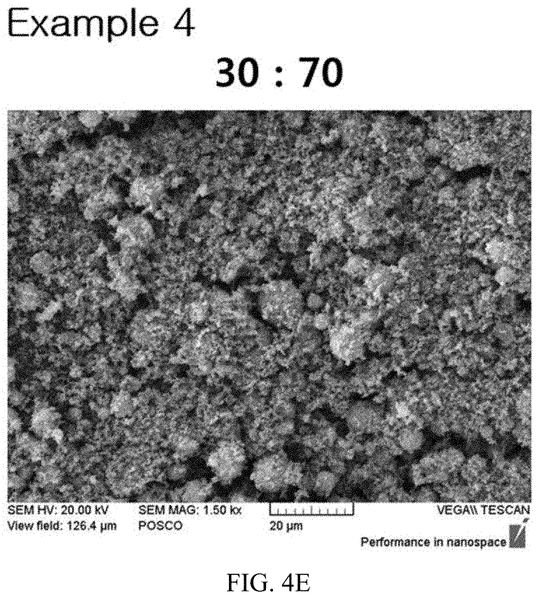

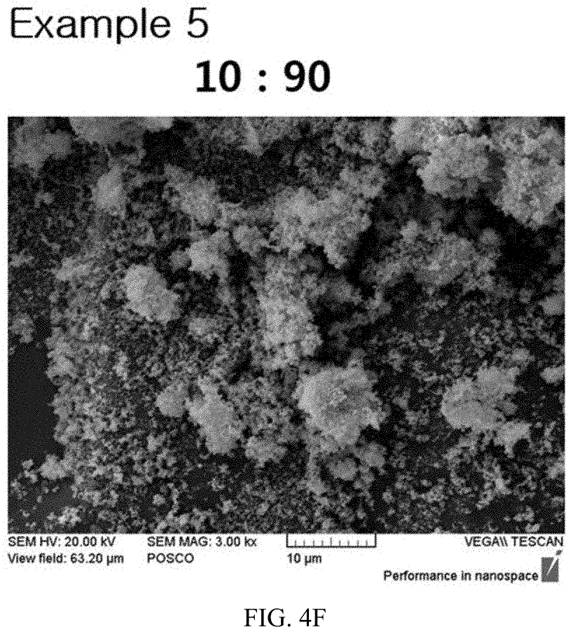

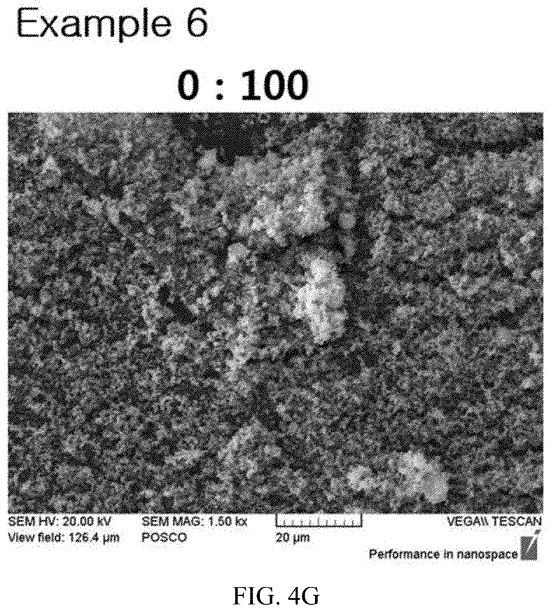

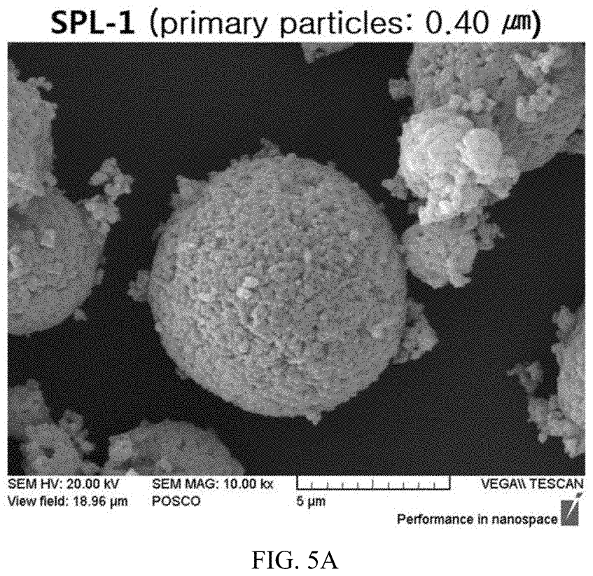

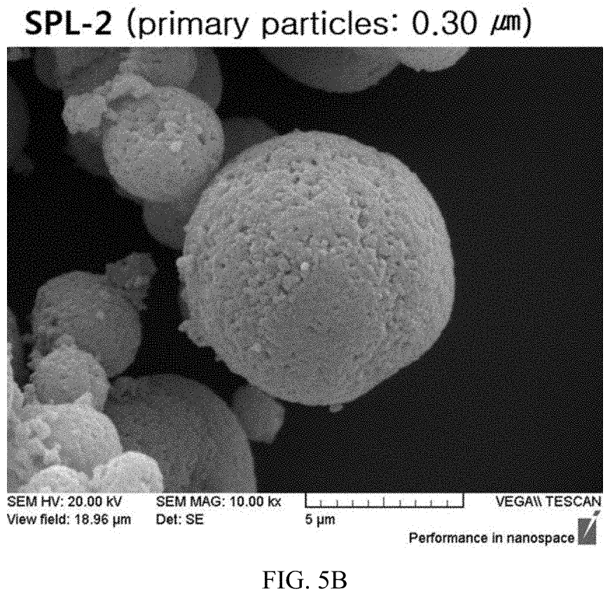

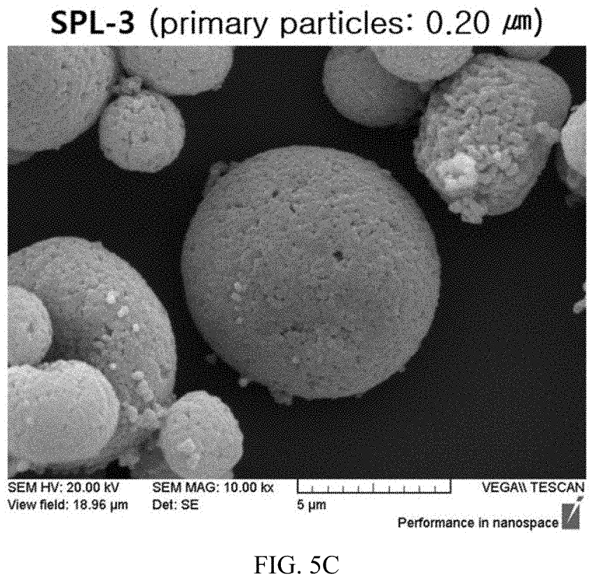

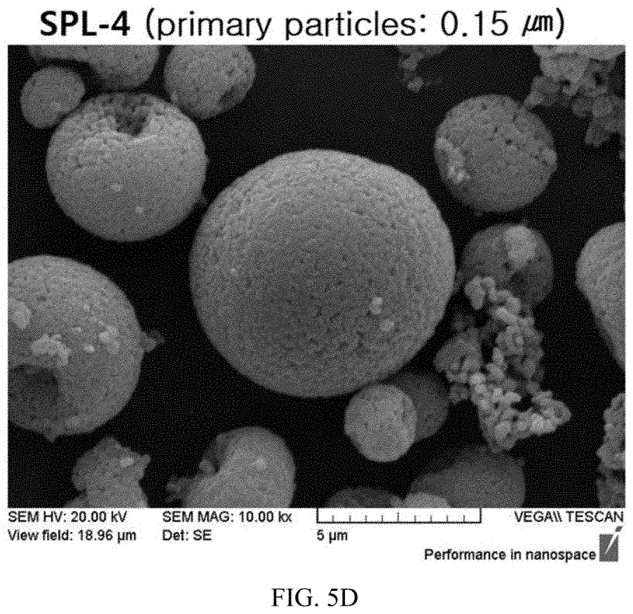

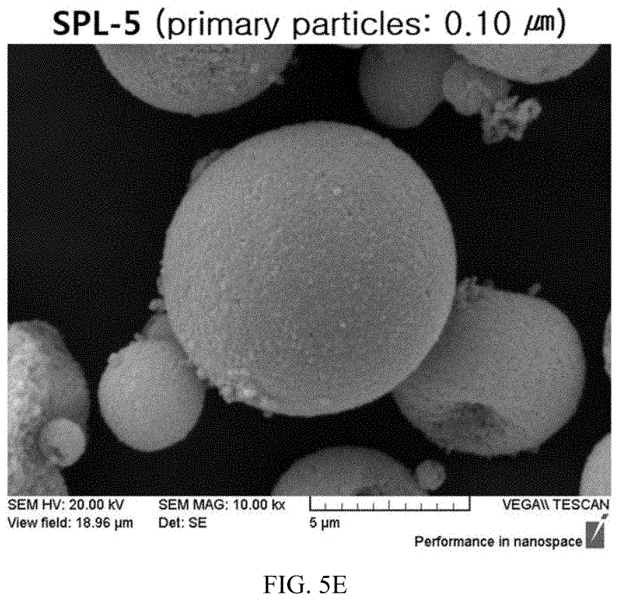

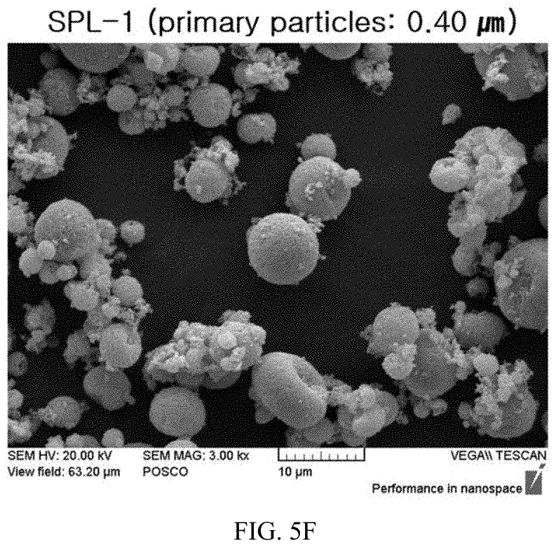

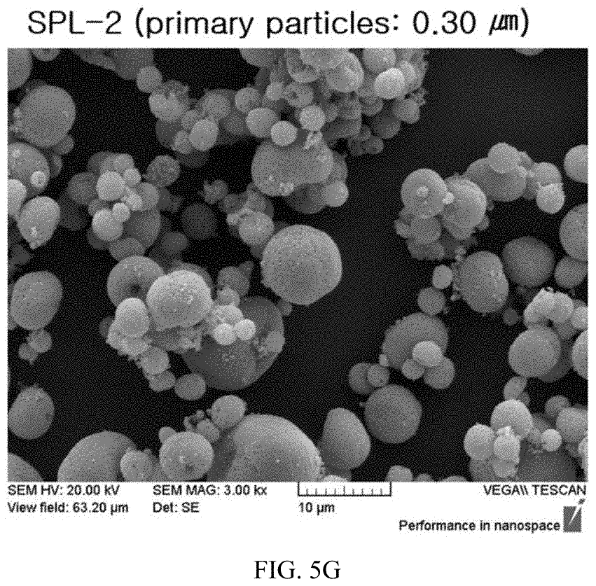

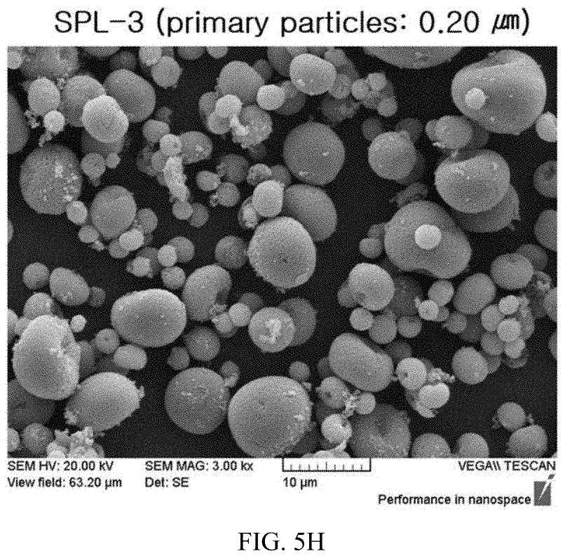

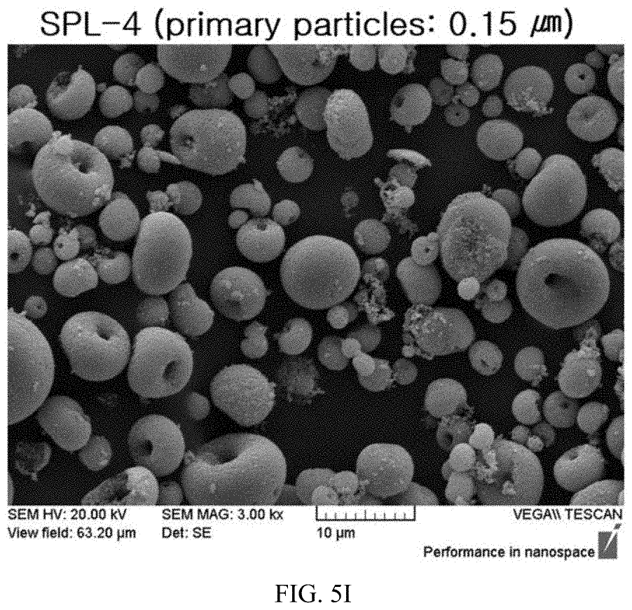

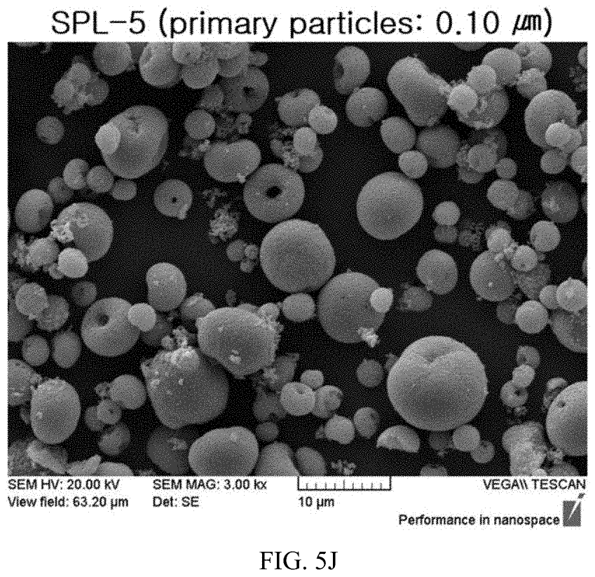

After measuring tap densities and pellet densities of the active materials prepared in Examples and Comparative Example 1, measurement results are shown in Table 1 and FIG. 4A to FIG. 4G.

Table 1 shows that the more the contents of Li₂CO₃ added as the pore inducting material are increased, the more the tap densities are decreased.

After preparing particles by varying addition amounts of Li₂CO₃ added as the pore inducing material, SEM photographs of the prepared particles are shown in FIG. 4A to FIG. 4G. It can be seen in FIG. 4A to FIG. 4G that the more the addition amounts of Li₂CO₃ added as the pore inducing material are increased, the more pellet densities are increased. This can be seen from a reason that, when the pore inducing material is added in an excessive amount, the pellet densities are rather increased while the particles are being cracked.

### EXPERIMENTAL EXAMPLE

### Measurement of Weight Ratios of Anatase Phase TiO₂ To Rutile Phase

### TiO₂

After measuring pore volumes and pore sizes of the active materials prepared in Examples and Comparative Example 1, measurement results are shown in the following Table 4.

TABLE 4

| | | LiOH:Li₂CO₃ | | | | | | |
|---|---|---|---|---|---|---|---|---|
| Items | Unit | 100:0 | 90:10 | 70:30 | 50:50 | 30:70 | 10:90 | 0:100 |
| Pore | cm³/g | 0.0239 | 0.0231 | 0.0227 | 0.0223 | 0.0191 | 0.0190 | 0.0186 |
| volume | | | | | | | | |
| Pore | nm | 24.6575 | 17.9271 | 15.7095 | 15.2178 | 12.3167 | 11.5216 | 10.0913 |
| size | | | | | | | | |

It can be seen that the pore volumes and the pore sizes are decreased since the more addition amounts of Li₂CO₃ that is the pore inducing material are increased, the smaller and the more uniformly the pores are dispersed and formed to be.

### EXPERIMENTAL EXAMPLE

### Measurement of Pore Volumes and Pore Sizes

After measuring weight ratios of anatase phase TiO₂ to rutile phase TiO₂ from the active materials prepared in Examples and Comparative Example 1, measurement results are shown in the following Table 5.

It can be confirmed in the following Table 5 that the active materials prepared by the present invention comprise 3.0 wt % or less of the rutile phase TiO₂.

TABLE 5

| Ratio of Anatase | | | | | | | | |
|---|---|---|---|---|---|---|---|---|
| phase TiO₂ to | | LiOH:Li₂CO₃ | | | | | | |
| Rutile phase TiO₂ | | 100:0 | 90:10 | 70:30 | 50:50 | 30:70 | 10:90 | 0: 100 |
| A-TiO₂ | % | 0.0 | 0.0 | 0.0 | 0.0 | 0.0 | 0.0 | 0.0 |
| R-TiO₂ | | 2.0 | 1.8 | 2.6 | 2.0 | 1.2 | 0.9 | 0.8 |

### MANUFACTURING EXAMPLE

### Manufacturing of Coin Cells

Coin cells were manufactured from the active materials prepared in Examples and Comparative Example 1 according to a commonly known manufacturing process by using lithium metal as a counter electrode and a porous polyethylene film as a separator, and using a liquid electrolyte which is dissolved at 1 mol concentration in a solvent having ethylene carbonate and dimethyl carbonate mixed therein at a volume ratio of 1:2.

### EXPERIMENTAL EXAMPLE

### Evaluation of Initial Charge and Discharge Characteristics

After measuring initial charge and discharge characteristics at 0.1 C using an electrochemical analyzer in order to evaluate test cells comprising the active materials prepared in Examples and Comparative Example 1, measurement results are shown in Table 6.

### EXPERIMENTAL EXAMPLE

### Evaluation of Rate Properties

After evaluating rate properties of the test cells by charging the test cells at 0.1 C and discharging the test cells at 0.1 C and 10 C using the electrochemical analyzer in order to evaluate test cells comprising the active materials prepared in Examples and Comparative Example 1, evaluation results are shown in Table 6.

TABLE 6

| | Charge and discharge characteristics | | Rate properties |
|---|---|---|---|
| | 0.1 C Discharge | 0.1 C Efficiency | 10 C/0.1 C |
| Classification | [mAh/g] | [%] | [%] |
| Comparative | 170.1 | 98.5 | 83 |
| Example | | | |
| Example 1 | 165.7 | 98.5 | 92 |
| Example 2 | 168.0 | 98.1 | 93 |
| Example 3 | 166.4 | 97.9 | 90 |
| Example 4 | 167.1 | 97.3 | 88 |
| Example 5 | 167.2 | 97.5 | 83 |
| Example 6 | 170.2 | 97.5 | 90 |
| Example 7 | 165.0 | 98.3 | 91 |
| Example 8 | 164.0 | 98.0 | 92 |
| Example 9 | 165.8 | 98.1 | 91 |
| Example 10 | 165.9 | 97.6 | 93 |
| Example 11 | 168.0 | 98.3 | 90 |
| Example 12 | 166.1 | 98.0 | 92 |
| Example 13 | 166.9 | 98.5 | 90 |
| Example 14 | 167.0 | 97.7 | 90 |
| Example 15 | 167.4 | 98.5 | 87 |
| Example 16 | 166.0 | 98.3 | 90 |
| Example 17 | 170.0 | 98.7 | 90 |
| Example 18 | 168.6 | 98.3 | 90 |

It can be confirmed in the above Table 6 that cells comprising active materials prepared by adding the pore inducing material by the present invention have greatly improved charge and discharge characteristics and rate properties.

A preparation method according to the present invention can prepare a lithium-titanium complex oxide which is prepared from a particle size-controlled slurry having sizes of primary particles reduced by adding a pore inducing material in the wet-milling step such that appropriate pores are contained within the particles.

Since a lithium-titanium complex oxide having sizes of the primary particles reduced, the lithium-titanium complex oxide prepared according to the preparation method according to the present invention shortens a moving distance of lithium ions by adding the pore inducing material, diffusion rate of the lithium ions is increased. Thereby, a battery comprising the lithium-titanium complex oxide according to the preparation invention exhibits excellent output characteristics as the lithium-titanium complex oxide becomes favorable to electron transport.

1. A lithium-titanium complex oxide characterized by having a molar ratio of lithium to titanium (Li/Ti ratio) of 0.80 to 0.85.

2. The lithium-titanium complex oxide of claim 1, comprising 5 wt % or less of a rutile-type titanium oxide.

3. The lithium-titanium complex oxide of claim 1, comprising 0.05 mol/L or less of Zr.

4. The lithium-titanium complex oxide of claim 1, having a Brunauer-Emmett-Teller (BET) surface areas of 4.3 m²/g or more.

5. The lithium-titanium complex oxide of claim 1, having a tap density of 1.0 g/cm³ or more and a pellet density of 1.75 g/cm³ or more.

6. A preparation method of the lithium-titanium complex oxide according to claim 1, the preparation method comprising:
of solid phase-mixing a pore inducing compound, a titanium compound, and a dissimilar metal-containing compound at a stoichiometric ratio to obtain a solid phase mixture;
of preparing a slurry in which primary particles are dispersed by dispersing the solid phase mixture in a solvent and wet-milling the solid phase mixture dispersed in the solvent;
of forming secondary particles by spray drying the slurry;
of mixing the secondary particles with a lithium-containing compound to obtain lithium compound-mixed particles;
calcining the lithium compound-mixed particles to obtain calcined particles; and
classifying the calcined particles.

7. The preparation method of claim 6, wherein the pore inducing compound is one or more selected from lithium carbonate (Li₂CO₃), sodium bicarbonate (NaHCO₃), and potassium carbonate (K₂CO₃).

8. The preparation method of claim 6, wherein the titanium compound is one or more selected from the group consisting of titanium dioxide (TiO₂), titanium chloride, titanium sulfide, and titanium hydroxide.

9. The preparation method of claim 6, wherein the dissilimar metal is one or more selected from the group consisting of Na, Zr, K, B, Mg, Al, and Zn.

10. The preparation method of claim 6, wherein the wet-milling comprises wet-milling the solid phase mixture dispersed in the solvent by using water as the solvent and using zirconia beads having a rotational speed of 2,000 to 5,000 rpm.

11. The preparation method of claim 10 claim 6, wherein the primary particles have an average particle diameter D₅₀ of 0.05 to 0.4 μm.

12. The preparation method of claim 6, wherein the third step of performing the spray drying process comprises spray drying the slurry at a hot air input temperature of 200 to 300° C. and a hot air exhaust temperature of 100 to 150° C.

13. The preparation method of claim 6, wherein the second particles obtained by spray drying the slurry have an average particle diameter D₅₀ of 5 to 20 μm.

14. The preparation method of claim 6, wherein the lithium-containing compound is lithium hydroxide (LiOH) or lithium carbonate (Li₃CO₂).

15. The preparation method of claim 6, wherein the calcining is performed at a temperature of 700 to 800° C. in an air atmosphere for 10 to 20 hours.

16. The preparation method of claim 6, wherein classifying the calcined particles comprises classifying the calcined particles to a particle size corresponding to a sieve size of 200 to 400 meshes.
